(19) United States
(12) Patent Application Publication
(10) Pub. No.: US 2005/0138851 A1
(43) Pub. Date: Jun. 30, 2005

(54) New year's ball drop

(76) Inventor: Joseph Vito Ingraselino, Medford, NY (US)

Correspondence Address: JOSEPH V. INGRASELINO, 79 ROBINSON AVE., MEDFORD, NY, 11763, US

(21) Appl. No.: 10/749,307

(22) Filed: Dec. 30, 2003

(51) Int. Cl. G09F 13/00

(52) U.S. Cl. 40/442; 40/544

(57) ABSTRACT

The present invention 10 discloses a New Year's celebrating device having a vertically standing support pole 16 having tracks 18 thereon upon which a movable ball 12 is slidably mounted. The ball 12 also has lights 14 there on. A New Year display sign 20 having lights 22 thereon. In operation, at a predetermined time, the ball 12 begins its descent from atop the pole 16. When the ball 12 reaches its destination at the bottom of the pole 16, the New Year display lights 22 light up and the ball lights 14 flash.

### BACKGROUND OF THE INVENTION

1. Field of the Invention

The present invention relates generally to illuminated celebratory devices and, more specifically, to a New Year's Ball Dropping down a vertical support pole reaching the bottom at a predetermined time there by, activating the lights on a year display sign and flashing the ball lights to announce the onset of the New Year's Celebration.

2. Description of the Prior Art

There are other illuminated devices designed for celebrations. Typical of these is U.S. Pat. No. 6,260,989 issued to Joseph V. Ingraselino on Jul. 17, 2001.

A second patent was issued to Lonnie Lawrence on Feb. 11, 1997: U.S. Pat. No. 5,601,361. A third U.S. Pat. No. 5,090,789 was issued to Allen E. Crabtree on Feb. 25, 1992 and a fourth was issued on Jun. 21, 1983 to Robert M. Smith as U.S. Pat. No. 4,389,589.

### U.S. Pat. No. 6.260,989

### Inventor: Joseph V. Ingraselino

### Issued: Jul. 17, 2001

A synchronized confetti sprayer and descending illuminated ball. An illuminated celebratory device having a confetti blower housing with LED digital display and other visual and sound effects mounted on top of a vertically standing pole having tracks thereon upon which a movable ball is mounted. The ball also has digital displays and lamps thereon. The pole is mounted on a base stand. In operating at a predetermined time the ball begins its descent from atop the pole and as it descends, pole lamps illuminate and the LED's show the appropriate time. When the ball reaches its destination at the bottom of the pole, LED's indicate the appropriate time and all celebratory features of the device activate.

### U.S. Pat. No. 5,601,361

### Inventor: Lonnie Lawrence

### Issued: Feb. 11, 1997

A movable and flexible net arranged in an M×N pattern is set forth. The pattern is defined by a plurality of parallel strands having eyelets therein to releasably engage and hold lamps in a light string. The net of the present disclosure, while supporting an attached light string, can be draped to any contour determined by a supportive surface, and can be likewise positioned in a deployed pattern with that contour or stored for later use. The net in the M×N rectangular pattern is formed of flexible strands to enable storage.

### U.S. Pat. No. 5,090,789

### Inventor: Allen E. Crabtree

### Issued: Feb. 25, 1992

A laser light show device and method produces a surface projected or suspended holographic image, and includes multiple image projectors. One image projector provides the object image information representing the primary subject. For surfaces projections, additional background image projectors provide background image information generated using a wobbler plate-reflected beam diffracted through a spherical lens, a beam undimensionally diffracted through a rotating cylindrical amorphic dipolyhedral, and a beam diffracted through multiple diffraction gratings. A suspended holographic is produced by parabolically focusing multiple images projected onto a spherical image screen.

### U.S. Pat. No. 4,389,598

### Inventor: Robert M. Smith

### Issued: Jun. 21, 1983

A disco light assembly which includes a multiplicity of individual electric lamps formed in a circle, or in any other appropriate configuration, and which are illuminated in any desired sequence in response to a disco beat. The individual lamps are preferably of the high intensity type, and each generates a shaft of light, preferably white, when illuminated. A common regulated power supply is provided which supplies a continuous filament current to all the lamps which is of sufficient amplitude to maintain the filaments in a warm state but insufficient to illuminate the lamps. Each lamp has its own control module connected to the common power supply, when a module is triggered; it causes a high current pulse to be introduced to the corresponding lamp for a few milliseconds, followed by a power current of sufficient intensity to illuminate the lamp. The power current continues for so long as the lamp is to be illuminated. A rapid turn-on circuit is included in each module, so that each lamp is turned on without creating any undue thermal stress in the lamp filament. However, the lamps turn off at a relatively slow rate. This obviates irritating strobe light effects.

While these illuminated celebratory devices may be suitable for the purposes for which they were designed, they would not be as suitable for the purposes of the present invention, as hereinafter described.

### SUMMARY OF THE PRESENT INVENTION

The present invention discloses an New Year's celebratory device mounted on top of a vertically standing pole having tracks thereon upon which a movable ball is slidably mounted. The lighted ball begins its descent, at a predetermined time, from atop the pole. When the ball reaches its destination at the bottom of the pole a sign displaying the new year lights up and the ball lights begin flashing.

A primary object of the present invention is to provide a New Year's Ball Drop wherein, the ball reaches the bottom of its vertical support post precisely at a predetermined time where upon a new year display sign lights up to announce the celebration of the New Year.

Another object of the present invention is to provide a New Year's Ball Drop having a multiplicity of lamps on or within the surface of the ball.

Yet another object of the present invention is to provide a New Year's Ball Drop tracking mechanism to guide the movement of the ball.

Still yet another object of the present invention is to provide a New Year's Ball Drop multiplicity of lamps on or with in the surface of a new year display sign i.e. “2004.”

A further object of the present invention is to provide a New Year's Ball Drop including a timing device to assure the synchronicity of the ball reaching its destination activating the new year display sign lights and flashing the ball lights with the accurate moment to celebrate.

The present invention overcomes the short comings of the prior art by providing a New Year's Ball Drop for the celebration of New Year's having an illuminated ball including a timing device assure the ball reaches its destination at a precise moment of celebration and lighting up a New Year display sign.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is a front view of the present invention when showing the ball in the raised and ready position. A track mechanism runs through the vertical pole and is shown in hidden line. The new year display sign is not illuminated at this time.

FIG. 2 is a front view of the present invention activated. The ball lights are lit. The ball is ready to begin its descent down the vertical support pole.

FIG. 3 is a front view of the present invention in operation; shown is the ball in mid-descent.

FIG. 4 is a front view of the present invention after the ball has reached its destination. The year display sign is fully illuminated and the lights on the ball are flashing.

### LIST OF REFERENCE NUMERALS

With regard to reference numerals used, the following numbering is used throughout the drawings.
10 present invention
12 ball
14 ball lights
16 vertical support pole
18 track mechanism to guide the ball during its descent
20 new year display sign
22 display lights
24 power source
26 timed drive mechanism to power lowering the ball

### DESCRIPTION OF THE PREFERED EMBODIMENT(S)

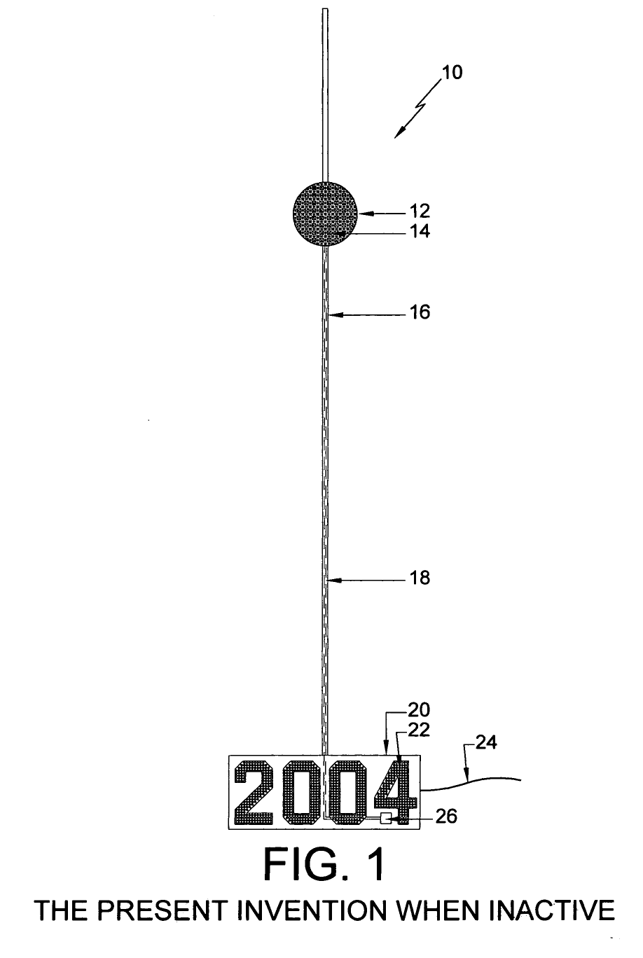

In order that the invention may be more fully understood, it will now be described, by way of example, with reference to the accompanying drawings in which FIGS. 1 through 4 illustrate the present invention being a New Year's Ball Drop.

Turning to FIG. 1, shown therein is a front view of the present invention 10 when dormant showing the ball 12 in the raised and ready position. A track mechanism 18 which guides the ball during its descent runs through the vertical support pole 16 and is shown in hidden line. Also shown are the ball lights 14, and the new year display sign 20 having a multiplicity of display lights 22. The ball drive mechanism 26 is shown as well as the power source 24.

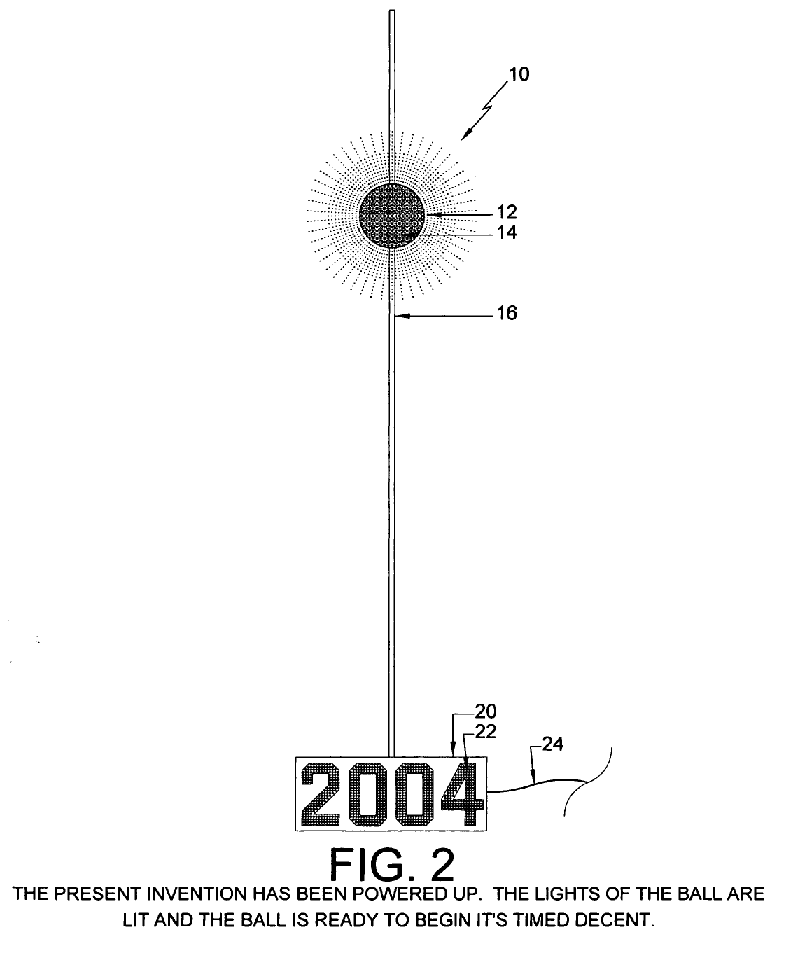

Turning to FIG. 2, shown therein is a front view of the present invention 10 activated. The ball lights 14 are lit. The ball 12 is ready to begin its timed descent down the vertical support post 16. Elements previously disclosed are also shown.

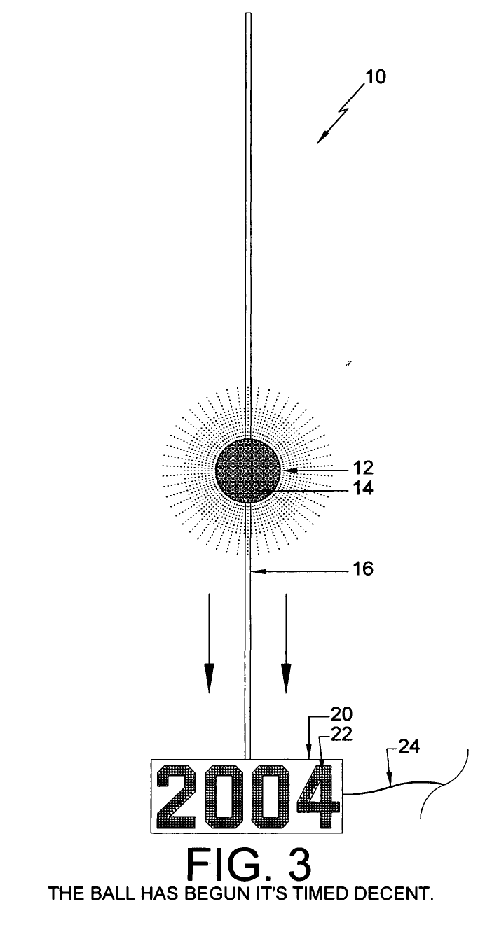

Turning to FIG. 3, shown therein is a front view of the present invention 10 in operation. Shown is the ball 12 in mid-descent with all ball lights 14 lit. Elements previously disclosed are also shown.

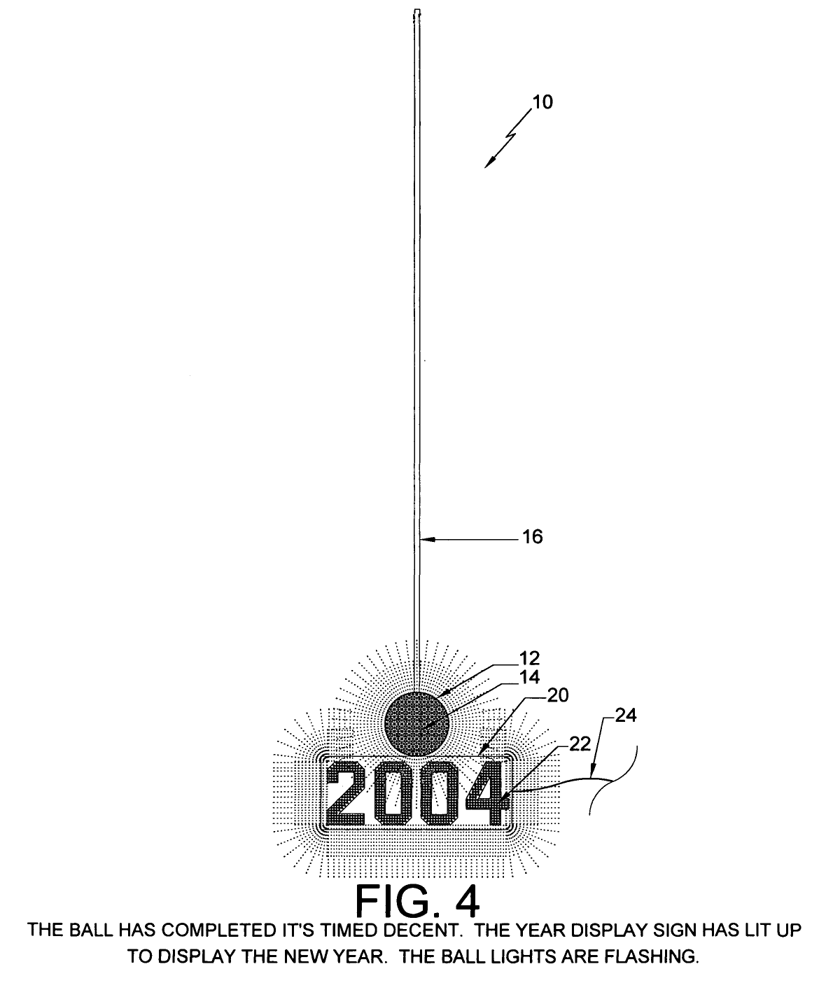

Turning to FIG. 4, shown therein is a front view of the present invention 10 in full operation after the ball 12 has reached its destination. The ball lights 14 are flashing. The new year display lights 12 are illuminated showing the New Year. Elements previously shown are also shown.

1. An apparatus for a New Year's celebrating device, comprising:
a) a vertically standing support pole;
b) a track mechanism disposed on said support pole;
c) a ball vertically movable disposed on said support pole being vertically movable on said track mechanism;
d) a plurality of lights disposed on said ball;
e) means for a drive mechanism for said ball;
f) a source of electrical power for the apparatus;
g) a year sign displaying the new year at the base of said support pole;
h) a plurality of lights disposed on said year sign.

2. The apparatus of claim 1, said ball further comprising means for a plurality of externally projecting lights.

3. The apparatus of claim 1, said ball further comprising means for a light emitting diode.

4. The apparatus of claim 1, said new year sign further comprising means for a plurality of externally projecting lights.

5. The apparatus of claim 1, said new year sign further comprising means for a light emitting diode.
